(19) United States
(12) Patent Application Publication
(10) Pub. No.: US 2006/0080339 A1
(43) Pub. Date: Apr. 13, 2006

(54) Content reproducing apparatus and a content reproducing method

(75) Inventor: Jeong-il Choi, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/218,500

(22) Filed: Sep. 6, 2005

(30) Foreign Application Priority Data
Oct. 11, 2004 (KR) 200480874

(51) Int. Cl. G06F 7/00

(52) U.S. Cl. 707/100

(57) ABSTRACT

A content reproducing apparatus and a content reproducing method. The content reproducing apparatus for reproducing a content to be displayed through an external output device and providing the reproduced content to the external output device, includes: a playlist (PL) information storage storing information relating to a PL including at least one content list (CL) that includes at least one content; a user input section defining a PL-registered content to be registered to the PL, from the content to be reproduced during the reproduction of the content; and a controller controlling updating of information relating to the PL by applying information relating to the defined PL-registered content. Accordingly, by setting the PL with the easy and simple manipulation, the user's time and effort are not unnecessarily wasted.

### CROSS-REFERENCE TO RELATED APPLICATION

This application claims the benefit under 35 U.S.C. § 119 (a) from Korean Patent Application No. 2004-80874 filed on Oct. 11, 2004 in the Korean Intellectual Property Office, the entire disclosure of which is incorporated herein by reference.

### BACKGROUND OF THE INVENTION

1. Field of the Invention

The present invention relates generally to a content reproducing apparatus and a content reproducing method. More particularly, the present invention relates to a content reproducing apparatus and a content reproducing method for providing a user with content such as video and audio.

2. Description of Related Art

Content reproducing apparatuses reproduce video and/or audio contents from mass storage recording media such as hard disk drives (HDDs), or read and output the reproduced content from optical disks to an external output device.

A content reproducing apparatus has a playlist (PL) function. The PL function enables users to define desired content parts using only time information with respect to a plurality of contents written to a mass storage recording medium or an optical disk, and to specify a reproduction order of the defined content parts. Hereinafter, the contents including the defined content parts are referred to as PL-registered contents, and a set of the PL-registered content having the specified reproduction order is referred to as a content list (CL). A set of more than one CL is referred to as a PL. Users can select at lest one CL in the PL of the individual content reproducing apparatus. When reproducing one CL in the PL, the one CL is reproduced according to its specified reproduction order, without regard to the recording order of the contents to the mass storage recording media or the optical disks.

In the conventional art, to register the PL-registered contents to the PLs, the users have to edit the PLs through a PL setup menu screen separately from the reproduction of the contents. To be specific, the users display the PL setup menu screen in relation with one CL, selects a start point and an end point within the content to be registered to the PL, and thus designates the PL-registered content. Next, the users register the designated PL-registered content to the relevant CL. By contrast, to register the PL-registered content to another CL, the users need to display a PL setup menu screen of the another CL by moving back to the PL setup menu screen of the one CL.

In this situation, the user can appoint a reproduction location of the relevant CL to which the PL-registered content is registered. Thus, when reproducing the relevant CL, the user can view the PL-registered contents at the appointed reproduction location.

In the conventional art, the users experience inconvenience when specifying the PL separately from the content reproduction for the display. To be specific, additional time and effort are required to reproduce the content in the separate PL setup menu used to specify the PL. Furthermore, it is not easy for the user to set the PL since the PL setup menu screen is applied to the individual CL.

### BRIEF SUMMARY

An aspect of the present invention provides a content reproducing apparatus and a content reproducing method for registering a part of or the whole contents to a playlist (PL) during the reproduction of contents so that a user needs not to set the PL through a separate PL setup menu screen.

In the aspect of the present invention, a content reproducing apparatus for reproducing a content to be displayed through an external output device and providing the reproduced content to the external output device, includes: a playlist (PL) information storage for storing information relating to a PL including at least one content list (CL) that includes at least one content; a user input section for defining a PL-registered content to be registered to the PL, from the content to be reproduced during the reproduction of the content; and a controller for controlling to update information relating to the PL by applying information relating to the defined PL-registered content.

The PL-registered content may be defined based on a start point and an end point when the start point and the end point of the PL-registered content is selected in the content to be reproduced through the user input section.

The controller may control registration of a new CL to information relating to the PL when it is requested to register the PL-registered content to the new CL with respect to the PL and a title of the new CL is input through the user input section.

The controller may control registration of the PL-registered content to the new CL.

The controller may control registration of the PL-registered content to a certain selected CL when it is requested to register the PL-registered content to an existing CL included in the PL and the certain CL is selected from the existing CL through the user input section.

The controller controls registration of the PL-registered content to a designated reproduction location when the reproduction location where the PL-registered content is registered in the certain CL, is designated through the user input section.

The controller may use a control program stored in a nonvolatile storage.

In another aspect of the present invention, a content reproducing method for reproducing a content to be displayed through an external output device and providing the reproduced content to the external output device, includes: reproducing the content to be reproduced; defining a playlist (PL)-registered content to be registered to a PL from the content to be reproduced during the content reproduction, the PL including at least one content list (CL) that includes at least one content; and updating information relating to the PL by applying information relating to the designated PL-registered content.

In another aspect of the present invention, a content reproducing method includes: outputting selected content to an external output device and displaying the selected content; temporarily storing information relating to a set start point of a playlist (PL)-registered content; temporarily storing the information relating to a defined end point of the PL-registered content, after reproducing the selected content for a certain length of time; determining whether to register the PL-registered content to a new content list (CL) or an existing CL; temporarily storing a title of the PL-registered content and a title of the new CL when the PL-registered is to be registered to the new CL and updating and storing the title of the PL-registered content and the title of the new CL; and temporarily storing a title of the PL-registered content when the PL-registered content is to be registered to an existing CL, determining whether a target CL has been selected, determining whether a reproduction location of the PL-registered content in the target CL when a target CL has been selected, and updating and storing the title of the PL-registered content and the title of the new CL.

Accordingly, by setting the PL with the easy and simple manipulation, the user's time and effort are not unnecessarily wasted.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates a content reproducing system according to an embodiment of the present invention;

FIG. 2 illustrates a structure of a content reproducing apparatus according to an embodiment of the present invention;

FIG. 3A depicts an exemplary initial playlist (PL) setup menu screen;

FIG. 3B depicts an exemplary PL setup menu screen displayed following the initial PL setup menu screen of FIG. 3A;

FIG. 3C depicts an exemplary PL setup menu screen which is displayed after a new register is selected in FIG. 3A and an OK button is selected in the PL setup menu screen of FIG. 3B;

FIG. 3D depicts an exemplary PL setup menu screen displayed after selecting an additional register in FIG. 3A and selecting the OK button in the PL setup menu screen of FIG. 3B; and

FIG. 4 is a flowchart explaining a content reproducing method according to an embodiment of the present invention.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

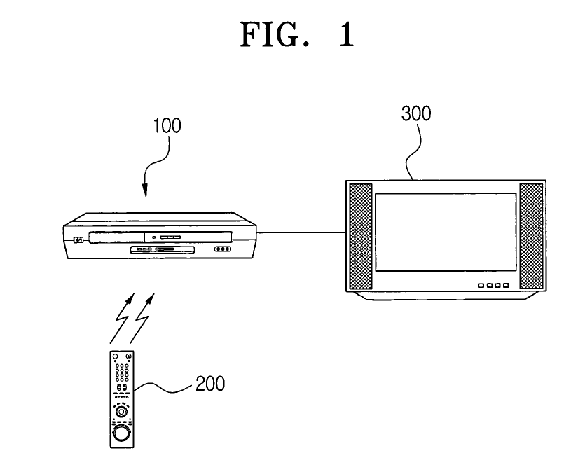

FIG. 1 schematically illustrates a content reproducing system according to an embodiment of the present invention.

As shown in FIG. 1, the content reproducing system includes a content reproducing apparatus 100 and an external output device 300. The content reproducing apparatus 100 reads and reproduces content to be output, such as video and/or audio, from a mass storage recording medium provided therein or a loaded optical disk. The external output device 300 displays the reproduced content to a user. The content reproducing apparatus 100 is controllable by a remote controller 200. The optical disk may be a storage medium allowing only reproduction such as a compact disk (CD)-read only memory (ROM) and a digital versatile disk (DVD)-ROM, a storage medium allowing data writing only once such as a CD-recordable (CD-R) and a DVD-R, and a storage medium allowing the data writing several times such as a CD-rewritable (CD-RW), a DVD-RW, and a DVD-random access memory (RAM). The content reproducing apparatus 100 may be a DVD player, a DVD recorder, a digital video recorder (DVR), and the like. The external output device 300 may be a television as shown in FIG. 1.

According to an embodiment of the present invention, when the content to be reproduced is provided from the content reproducing apparatus 100 to the external output device 300, the user can designate a playlist (PL)-registered content from the content to be reproduced by using the remote controller 200, and register the designated content to a PL.

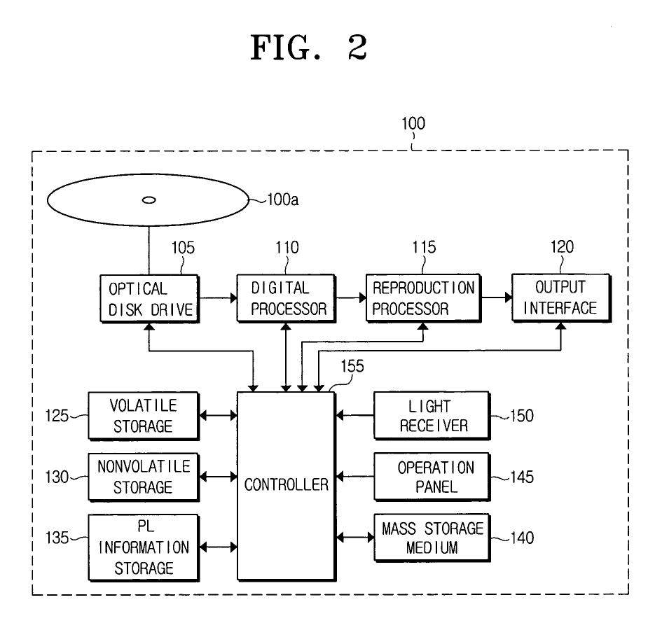

FIG. 2 is a block diagram of the content reproducing apparatus 100.

Referring to FIG. 1 and FIG. 2, the content reproducing apparatus 100 includes an optical disk drive 105, a digital processor 110, a reproduction processor 115, an output interface 120, a volatile storage 125, a nonvolatile storage 130, a PL information storage 135, a mass storage medium 140, an operation panel 145, a light receiver 150, and a controller 155.

The optical disk drive 105 irradiates a light beam onto an optical disk 100a loaded to the content reproducing apparatus 100, reads a content, i.e., a video content written to the optical disk 100a, and converts the read content to a RF signal.

The digital processor 110 is a digital signal processor that converts the RF signal to an electrical signal and digitizes the converted electrical signal. In short, the digital processor 110 digitizes a video signal and an audio signal included in the RF signal.

The reproduction processor 115 converts the video signal and the audio signal output from the digital processor 110, to a signal that can be output from the external output device 300.

The output interface 120 connects to the external output device 300. The output interface 120 forwards the converted signal from the reproduction processor 115 to the external output device 300, and forwards a menu screen stored in the PL information storage 135 to the external output device 300.

The volatile storage 125 temporarily stores data generated during the reproduction at the content reproducing apparatus 100, and data generated during other operations. Specifically, the volatile storage 125 temporarily stores information relating to a start point of the PL-registered content generated during the setting of the PL, information relating to an end point of the PL-registered content, information relating to a title of the PL-registered content, and information relating to a title of a new content list (CL).

The nonvolatile storage 130 contains a control program used to control and manage the operation of the content reproducing apparatus 100. The nonvolatile storage 130 can contain a coder-encoder (CODEC) program such as DVIX. The nonvolatile storage 130 may be a flash memory.

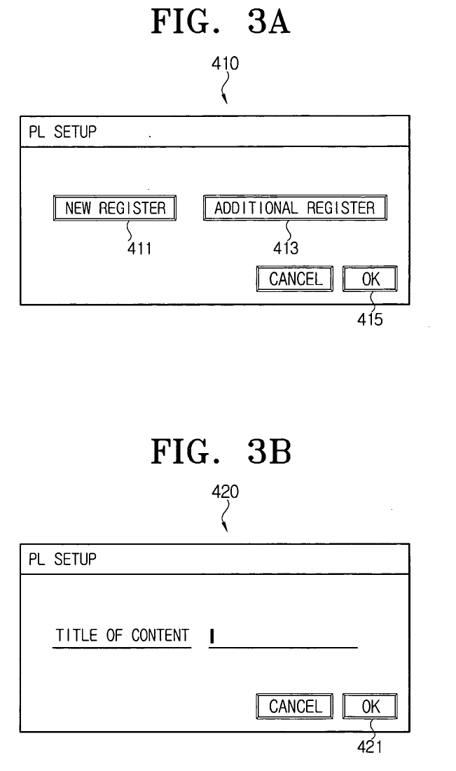

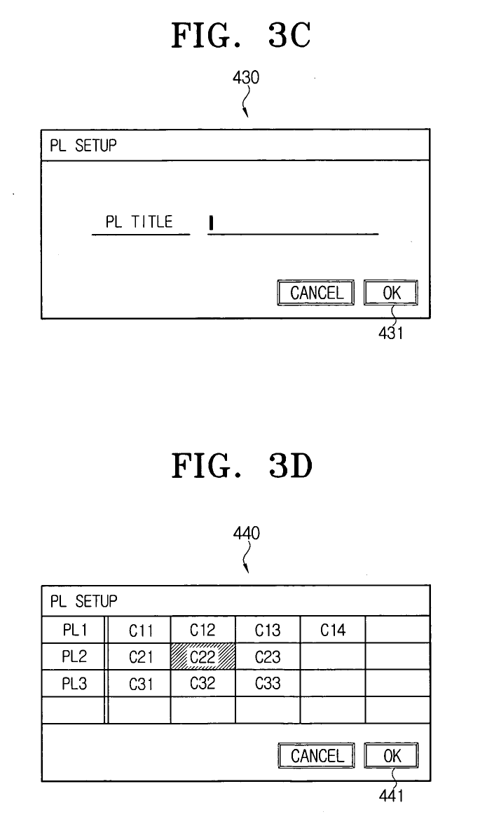

The PL information storage 135 stores information relating to the PL. In the this embodiment of the present invention, the PL information storage 135 stores information relating to the PL currently set at the content reproducing apparatus 100. Hence, the PL information storage 135 contains information relating to the CL of the current PL, that is, information relating to a storage location of each content and information relating to a reproduction order of the contents. In addition, the PL information storage 135 stores information relating to the designation of the PL-registered contents making the CL, i.e., information relating to the start point defining the PL-registered content from the contents and information relating to the start point for each of the PL-registered contents. In this embodiment of the present invention, the information temporarily stored to the volatile storage 125 during the setting of the PL are finally stored to the PL information storage 135 under the control of the controller 155, and the stored information are applied to PL setup menu screens 410, 420, 430, and 440 as shown in FIG. 3A through FIG. 3D. Subsequently, the stored information are utilized when the user reproduces the PL.

The PL information storage 135 stores the PL setup menu screens 410, 420, 430, and 440 as shown in FIG. 3A through FIG. 3D. The stored PL setup menu screens 410, 420, 430, and 440 are read and output to the external output device 300 through the output interface 120 under the control of the controller 155. The user can manipulate the setup of the menu screens through the remote controller 200 or the operation panel 145. It is to be understood that a separate storage may be used to store the menu screens alone.

The mass storage medium 140 stores a plurality of video content, audio content, and combination of video and audio content compressed according to a compression format. The mass storage medium 140 can be a hard disk drive (HDD). The compression format can be a Motion Picture Experts Group (MPEG) compression format.

The operation panel 145 is a user interface that outputs a user's operation signal indicating to select or execute functions supportable by the content reproducing apparatus 100. The operation panel 145 can include a plurality of operation keys, numeric keys, and movement keys.

The light receiver 150 is an interface that receives the user input signal from the remote controller 200. The light receiver 150 receives the user's operation signal from the remote controller 200 and provides the received operation signal to the controller 155.

The controller 155 controls the content reproducing apparatus 100 according to the control program contained in the nonvolatile storage 130. The controller 155 controls to read and process the contents stored in the mass storage medium 140 so that the contents can be output to the external output device 300 through the output interface 120.

FIG. 3A depicts an exemplary PL setup menu screen, specifically, an initial PL setup menu screen. FIG. 3B depicts an exemplary PL setup menu screen displayed following the PL setup menu screen of FIG. 3A, which is used to input the title of the PL-registered content. FIG. 3C is an exemplary PL setup menu screen displayed after selecting a new register button in FIG. 3A and selecting an OK button of the PL setup menu screen in FIG. 3B. The PL setup menu screen of FIG. 3C is used to input a title of a new CL. FIG. 3D depicts an exemplary PL setup menu screen displayed after selecting an additional register button in FIG. 3A and selecting the OK button in the PL setup menu screen of FIG. 3B. The PL setup menu screen of FIG. 3D is used to specify the storage locations of the target CL and the PL-registered content.

If the user inputs a PL setup confirm command through the remote controller 200 or the operation panel 145 during the content reproduction, the PL setup menu screen 410 as shown in FIG. 3A is retrieved from the PL information storage 135 under the control of the controller 155. The retrieved PL setup menu screen 410 is fed to and displayed at the external output device 300 through the output interface 120. Note that the PL setup menu screens 410, 420, 430, and 440 in FIGS. 3A through 3D may be displayed separately from a content reproducing screen on a part of the screen of the external output device 300 with the content reproducing screen scaled-down. Alternatively, the PL setup menu screens 410, 420, 430, and 440 may be displayed on the content reproducing screen according to on-screen display (OSD).

The PL setup menu screen 410 of FIG. 3A is provided with a new register button 411 and an additional register button 413. The new register button 411 is used to designate a new CL with respect to the PL-registered content and to register the PL-registered content to the new relevant CL. The additional register button 413 is used to select a target CL from the existing CLs with respect to the PL-registered content and to additionally register the selected CL to a relevant CL.

If the user selects the new register 411 and an OK button 415 in the PL setup menu screen 410 of FIG. 3A through the remote controller 200 or the operation panel 145, the PL setup menu screen 420 of FIG. 3B is retrieved and output from the PL information storage 135, and is displayed at the external output device 300 under the control of the controller 155. The user can input a title of the PL-registered content in the PL setup menu screen 420 as shown in FIG. 3B. Information relating to the title of the PL-registered content is temporarily stored to the volatile storage 125 under the control of the controller 155.

In the PL setup menu screen 420 of FIG. 3B, if the user inputs the title of the PL-registered content and selects the OK button 421 through the remote controller 200 or the operation panel 145, the PL setup menu screen 430 as shown in FIG. 3C is retrieved from the PL information storage 135, is output through the output interface 120, and is displayed at the external output device 300 under the control of the controller 155. The user can input a title of a new CL in the PL setup menu screen 430 through the remote controller 200 or the operation panel 145. The title of the new CL is temporarily stored to the volatile storage 125. When the user selects the OK button 431, the new CL is updated to the PL list in the PL setup menu screen 440 as shown in FIG. 3D, and the PL-registered content is registered to the new CL. To this end, the information temporarily stored in the volatile storage 125 are finally stored to the PL information storage 135.

If the user selects the additional register button 413 and the OK button 415 in the PL setup menu screen 410 of FIG. 3A through the remote controller 200 or the operation panel 145, the PL setup menu screen 420 as shown in FIG. 3B is displayed at the external output terminal 300. Next, when the user inputs the title of the PL-registered content in the PL setup menu screen 420, information relating to the title of the PL-registered content is temporarily stored to the volatile storage 125.

In FIG. 3B, if the user inputs the title of the PL-registered content and selects the OK button 421 in the PL setup menu screen 420 through the remote controller 200 or the operation panel 145, the controller 155 controls to retrieve the PL setup menu screen 440 as shown in FIG. 3D from the PL information storage 135 and to output the retrieved PL setup menu screen 330 to the external output device 300 through the output interface 120. Next, the user selects a target CL to which the PL-registered content is to be registered in the PL setup menu screen 440 of FIG. 3D through the remote controller 200 or the operation panel 145, and designates the reproduction location of the PL-registered content in the target CL. Subsequently, when the user selects the OK button 441, the PL-registered content is updated to the PL list in the PL setup menu screen 440 of FIG. 3D and registered to the selected CL at the designated reproduction location. The registration is completed by storing the information temporarily stored to the volatile storage 125, to the PL information storage 135. Accordingly, if the user reproduces the target CL, the PL-registered content is reproduced together.

In FIG. 3D, the target CL is a ‘PL2’, and the reproduction location of the PL-registered content is next to ‘C22’. If the user selects the OK button 441, the ‘PL2’ is arranged in the order of ‘C21, C22, C NEW, C23’. The ‘C NEW’ indicates the title of the PL-registered content. If the user chooses the ‘PL2’ in the PL list, the contents ‘C21, C22, C NEW, C23’ are reproduced in that order.

It is possible to display the PL setting menu screen 430 of FIG. 3C and the PL setup menu screen 440 of FIG. 3D, without displaying the PL setup menu screen 420 of FIG. 3B. In this situation, the title of the PL-registered content is applied to the title of the content to be reproduced.

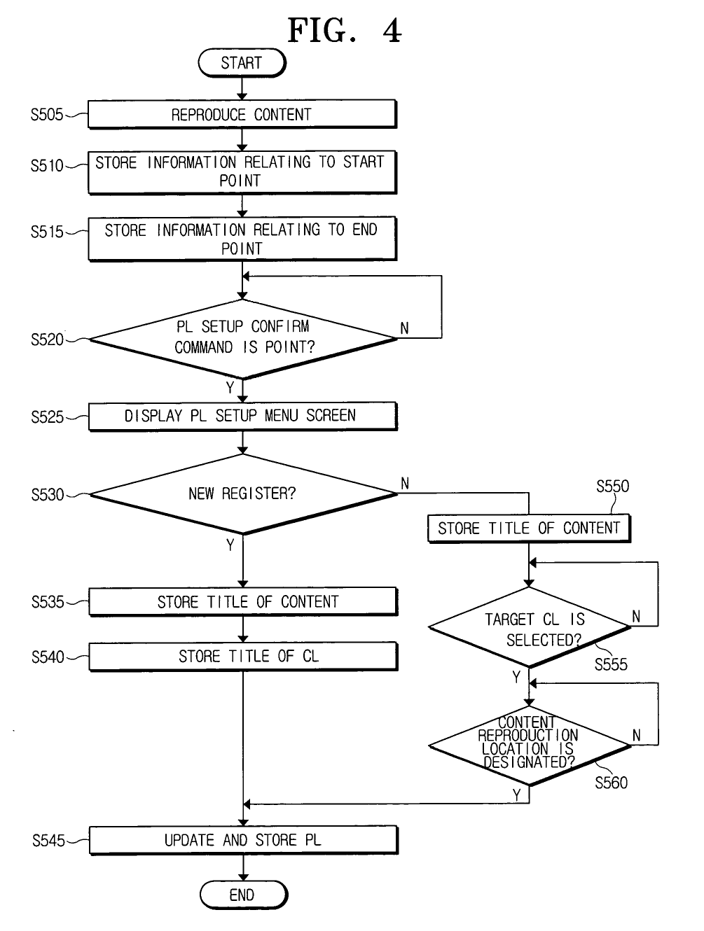

FIG. 4 is a flowchart explaining a content reproducing method according to an embodiment of the present invention.

Referring to FIG. 1 through FIG. 4, the user selects content to be reproduced among the contents stored to the mass storage recording medium 140 or the optical disk 100a, and inputs a content reproduction command. The selected content is output to the external output device 300 through the output interface 120 and is displayed to the user under the control of the controller 155 (S505).

When the user sets the start point of the PL-registered content through the remote controller 200 or the operation panel 145, the controller 155 controls the volatile storage 125 to temporarily store the information relating to the start point of the PL-registered content (S510).

After reproducing the selected content for a certain length time, when the user defines the end point of the PL-registered content with respect to the content through the remote controller 200 or the operation panel 145, the controller 155 controls the volatile storage 125 to temporarily store the information relating to the end point of the PL-registered content (S515). In result, the PL-registered content is specified by the start point and the end point of the PL-registered content.

When the user inputs the PL setup confirm command through the remote controller 200 or the operation panel 145 (S520), the controller 155 controls to output the PL setup menu screen 410 of FIG. 3A to the external output device 300 and to display the PL setup menu screen 410 to the user (S525).

The user determines whether to register the PL-registered content to either the new CL or the existing CL through the PL setup menu screen 410 of FIG. 3A (S530). The following operations are carried out depending on the user's determination.

If the user determines to register the PL-registered content to the new CL at operation S530, the PL setup menu screens 420 and 430 of FIGS. 3B and 3C are displayed to enable the user to input the title of the PL-registered content and the title of the new CL. After the user inputs the title of the PL-registered content and the title of the new CL, the title of the PL-registered content and the title of the new CL respectively are temporarily stored to the volatile storage 125 (S535 and S540).

When the user inputs a command indicating the completion of the PL setup, that is, when the user selects the OK button 431 in the PL setup menu screen 430, the title of the PL-registered content and the title of the new CL, which are temporarily stored, are updated and stored to the PL information storage 135 (S545).

Otherwise, if the user determines to register the PL-registered content additionally to the existing CL at operation S530, the PL setup menu screen 420 as shown in FIG. 3B is displayed to enable the user to input the title of the PL-registered content. When the user inputs the title of the PL-registered content, the volatile storage 125 temporarily stores the title of the PL-registered content (S550). Next, when the user selects the OK button 421 in the PL setup menu screen 420 of FIG. 3B, the PL setup menu screen 440 as shown in FIG. 3D is displayed to the user through the external output device 300.

The user selects the target CL to which the PL-registered content is to be registered through the PL setup menu screen 440 of FIG. 3D (S555), and designates the reproduction location of the PL-registered content in the target CL (S560). Next, when the user inputs the command for the PL setup completion, that is, when the user selects the OK button 441 in the PL setup menu screen 440 of FIG. 3D, the title of the PL-registered content being temporarily stored, is updated and stored to the PL information storage 135 (S545).

The content reproducing apparatus 100 has been described, by way of example, for the understanding of the present invention. It is to be understood that other embodiments of the present invention can adopt a content recording and reproducing apparatus capable of setting the PL during the content reproduction.

As explained above, the content reproducing apparatus and the content reproducing method enable the user to define the PL-registered content during the reproduction of the content, and updates the PL-registered content additionally to the PL. Therefore, the user needs not to set the PL separately from the content reproduction, through the PL setup menu screen. Since the user needs not to repeatedly reproduce the content to set the PL, the user's time and effort are not wasted unnecessarily. Furthermore, as the entire CL can be edited in a single PL setup menu screen, the user can conveniently edit the CLs.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A content reproducing apparatus for reproducing a content to be displayed through an external output device and providing the reproduced content to the external output device, comprising:
a playlist (PL) information storage storing information relating to a PL including at least one content list (CL) that includes at least one content;
a user input section defining a PL-registered content to be registered to the PL, from the content to be reproduced during the reproduction of the content; and
a controller controlling updating of information relating to the PL by applying information relating to the defined PL-registered content.

2. The content reproducing apparatus of claim 1, wherein the PL-registered content is defined based on a start point and an end point when the start point and the end point of the PL-registered content is selected in the content to be reproduced through the user input section.

3. The content reproducing apparatus of claim 1, wherein the controller controls registration of a new CL to information relating to the PL when it is requested to register the PL-registered content to the new CL with respect to the PL and a title of the new CL is input through the user input section.

4. The content reproducing apparatus of claim 3, wherein the controller controls registration of the PL-registered content to the new CL.

5. The content reproducing apparatus of claim 1, wherein the controller controls registration of the PL-registered content to a certain selected CL when it is requested to register the PL-registered content to an existing CL included in the PL and the certain CL is selected from the existing CL through the user input section.

6. The content reproducing apparatus of claim 5, wherein the controller controls registration of the PL-registered content to a designated reproduction location when the reproduction location where the PL-registered content is registered in the certain CL, is designated through the user input section.

7. The content reproducing apparatus of claim 1, wherein the controller uses a control program stored in a nonvolatile storage.

8. A content reproducing method for reproducing a content to be displayed through an external output device and providing the reproduced content to the external output device, the method comprising:
reproducing the content to be reproduced;
defining a playlist (PL)-registered content to be registered to a PL from the content to be reproduced during the content reproduction, the PL including at least one content list (CL) that includes at least one content; and
updating information relating to the PL by applying information relating to the designated PL-registered content.

9. The content reproducing method of claim 8, wherein the PL-registered content is defined based on a start point and an end point when the start point and the end point of the PL-registered content is selected in the content to be reproduced.

10. The content reproducing method of claim 8, wherein the information updating registers a new CL to information relating to the PL when a request to register the PL-registered content to the new CL with respect to the PL and a title of the new CL is input.

11. The content reproducing method of claim 10, wherein the information updating registers the PL-registered content to the new CL.

12. The content reproducing method of claim 8, wherein the information updating registers the PL-registered content to a certain selected CL when a request to register the PL-registered content to an existing CL included in the PL and the certain CL is selected from the existing CL.

13. The content reproducing method of claim 12, wherein the information updating registers the PL-registered content to a designated reproduction location when the reproduction location where the PL-registered content is registered in the certain CL, is designated.

14. The content reproducing method of claim 8, wherein the updating is controlled by a control program stored in a nonvolatile memory.

15. A content reproducing method, comprising:
outputting selected content to an external output device and displaying the selected content;
temporarily storing information relating to a set start point of a playlist (PL)-registered content;
temporarily storing the information relating to a defined end point of the PL-registered content, after reproducing the selected content for a certain length of time;
determining whether to register the PL-registered content to a new content list (CL) or an existing CL;
temporarily storing a title of the PL-registered content and a title of the new CL when the PL-registered is to be registered to the new CL and updating and storing the title of the PL-registered content and the title of the new CL; and
temporarily storing a title of the PL-registered content when the PL-registered content is to be registered to an existing CL, determining whether a target CL has been selected, determining whether a reproduction location of the PL-registered content in the target CL when a target CL has been selected, and updating and storing the title of the PL-registered content and the title of the new CL.
